(19) United States
(12) Patent Application Publication
(10) Pub. No.: US 2005/0175730 A1
(43) Pub. Date: Aug. 11, 2005

(54) Non-marking sealant tool

(75) Inventor: Wayne Belcher, Seahurst, WA (US)

Correspondence Address: DARBY & DARBY P.C., P. O. BOX 5257, NEW YORK, NY, 10150-5257, US

(73) Assignee: United Professional Caulking & Restoration, Inc., Seahurst, WA (US)

(21) Appl. No.: 10/774,976

(22) Filed: Feb. 9, 2004

(51) Int. Cl. B05C 17/12

(52) U.S. Cl. 425/458; 15/105.5

(57) ABSTRACT

A non-marking sealant tool is directed to applying sealant to structural joints. A shape and material of the tool are determined to minimize marking, damaging, scratching, and the like, of softer substrate materials including glass, painted tiles, and the like. At the same time, the shape and material of the tool are determined to maximize sealant performance by providing an optimum sealant shape. The tool comprises a handle and an applicator portion. The handle is shaped for comfortable fit in a user's hand and for ease and cost of manufacturing. The applicator portion has a maximum thickness along its longitudinal axis, which decreases approximately linearly toward its edges and provides optimum edge thickness for sealant application. A tip section of the applicator portion has a spline radius with a passive or aggressive shaped curvature.

### FIELD OF THE INVENTION

The present invention relates to sealant tools, and in particular, but not exclusively, to a non-marking sealant tool for use in applying sealants.

### BACKGROUND

Today's buildings have structural movement regardless of size, height, and width. To accommodate or cushion structural movement, there is a need for elastic joints at varying strategic locations throughout the exterior of a structure. In addition to the problem of potential torsion, seismic, or vibrational stresses, dimension and location of joints are directly related to tolerances and thermal movement characteristics of various substrates that make up the structure, potential shrinkage, design esthetics, and the like. Furthermore, location, dimension, and actual design of the joint will contribute to proper functioning of an exterior wall as it is exposed to rigors of daily weather and to climatic changes from season to season. Anticipated movement and changes in the structure may be accommodated by and considered in selecting a sealant to fill the joint.

Expansion or isolation joints prevent crushing and distortion (including displacement, buckling, and warping) of structural units due to expansion or settlement. They are used primarily to isolate walls from floors or roofs, columns from floors or cladding, pavement slabs and decks from bridge abutments, and the like.

Control joints are designed to control cracking that might occur from a contraction of a structure. They are used frequently to divide large, relatively thin structural units into smaller panels. Such structural units include pavements, floors, retaining and other types of walls, and the like.

A primary function of a joint sealant is to maintain a positive seal between the sides of a joint, which may be subject to movement. In non-structural applications, the sealant is not required to structurally support glass or panels, as in the case of structural silicone. Such applications include expansion joints, weather-seals, end dams, screw heads, kerf seals, splice joints, construction joints, contraction and isolation joints, control joints, butt joints, static and dynamic joints, structural glazing, curtain wall application, and the like. This type of sealant application helps to control the environment within the structure by resisting the passage of heat, light, sound, rain, snow, wind, odor, chemical and biological contaminants, and dust. At the same time, the sealant must withstand the effects of thermal conditions, moisture, and structural movement, including vibration and creep. In some cases, the sealant will be required to perform other functions, such as withstanding attack by insects, microorganisms, plants, or pollution. The successful performance of a building exterior is frequently defined by its ability to keep rain and other elements outside, away from the building's occupants. One of the critical links to ensuring a weatherproof building exterior is proper installation of joint sealant. Part of the sealant application process requires removing any excess sealant material delivered to the joint to prevent smearing.

Despite the importance of proper sealant application in structural joints, there is as yet no standard for an optimal shape in a sealant tool for addressing above discussed joint needs. Commercially available tools do not satisfy the need to apply sealant to nominal joint widths commonly encountered in construction industry, which may vary from 1/8 inch and to over 3 inches. Non-specialized tools such as spatulas, spoons, knives, and the like are commonly used in the industry for sealant purposes. Frequently, industry experts attempt to use stainless steel spatulas rounding their edges by grinding. The problem with using such tools is that they can damage softer substrates in construction such as glass, painted surfaces, enamels, tiles, and the like. These tools are often blamed for unsightly marks, scratches, or other kinds of damage creating additional cost for replacement or leading to claims against the installer. Furthermore, lack of proper tooling may be another major cause for failed sealants in building industry. Failed sealants are a leading cause of water-intrusion in commercial and residential construction. Litigation for water-intrusion, mold, and mildew is reported to exceed $13 billion in the US.

Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 illustrates an isomeric projection of a tool in accordance with one embodiment of the invention;

FIG. 2 illustrates a top view of the tool of FIG. 1;

FIG. 3 illustrates a side view of the tool of FIG. 1;

FIG. 4 illustrates a front view of the tool of FIG. 1;

FIG. 5 illustrates a partial top view of the applicator portion of a tool in accordance with one embodiment of the invention with a passive shaped curvature of the tip section;

FIG. 6 illustrates a partial top view of the applicator portion of a tool in accordance with another embodiment of the invention with an aggressive shaped curvature of the tip section;

FIG. 7 illustrates a side view of the tool of FIG. 1 used at a right angle to a substrate surface; and

FIG. 8 illustrates a side view of the tool of FIG. 1 used at an acute angle to a substrate surface.

### DETAILED DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. The following detailed description is, therefore, not to be taken in a limiting sense.

The terms “comprising,” “including,” “containing,” “having,” and “characterized by,” refers to an open-ended or inclusive transitional construct and does not exclude additional, unrecited elements, or method steps. For example, a combination that comprises A and B elements, also reads on a combination of A, B, and C elements.

The meaning of “a,” “an,” and “the” include plural references. The meaning of “in” includes “in” and “on.” Additionally, a reference to the singular includes a reference to the plural unless otherwise stated or is inconsistent with the disclosure herein.

The term “or” is an inclusive “or” operator, and includes the term “and/or,” unless the context clearly dictates otherwise.

The phrase “in one embodiment,” as used herein does not necessarily refer to the same embodiment, although it may.

The term “based on” is not exclusive and provides for being based on additional factors not described, unless the context clearly dictates otherwise.

Briefly stated, the present invention is directed to a non-marking sealant tool that may be used to apply various sealants including, but not limited to acrylic latex, single component polyurethanes, multi-component polyurethanes, modified sealants, silicones, epoxies, structural silicones for the glazing industry, and the like. Sealants may be applied to a variety of substrates including, but not limited to, brick, block, stone, glass, porcelain, painted or lacquered surfaces, plastics, mill finished aluminum, anodized aluminum, aluminum panels, copper, steel, stainless or galvanized steel, wood, tile, concrete, Exterior Finished Insulated Systems, and the like. The tool is structured and built of material configured to minimize marking, damaging, and scratching of softer architectural materials such as glass, painted substrates, tiles, and the like.

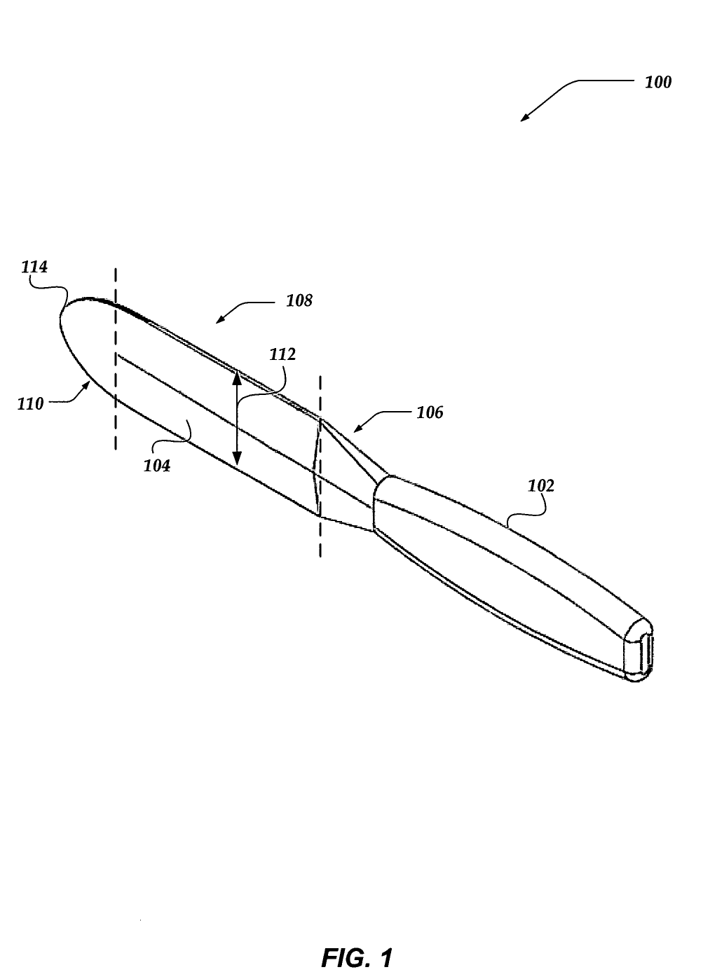

FIG. 1 illustrates an isomeric projection of tool 100 in accordance with one embodiment of the invention. Variations in the arrangement and type of the components may be made without departing from the spirit or scope of the invention.

As shown in the figure, tool 100 comprises handle 102 and applicator portion 104. A length, width, thickness and shape of handle 102 may be selected within a range to accommodate different hand sizes. It is preferable that handle 102 be sized and shaped for ease and cost of manufacturing as well as for comfortable gripping of tool 100. Handle 102 may be manufactured using a wide range of materials including plastic, fiberglass, wood, polyurethane, metal, and the like. Handle 102 may also be manufactured using the same material as applicator portion 104. In one embodiment, handle 102 and applicator portion 104 may be manufactured integrally therewith. Furthermore, handle 102 may have a smooth surface or be indented for ease of gripping. In another embodiment tool 100 may be manufactured employing a molded injection technique.

Applicator portion 104 comprises a neck section 106, middle section 108, and tip section 110. Handle 102 is joined to applicator portion 104 at the proximal end of neck section 106. Neck section 106 transitions at its distal end to middle section 108. Middle section 108 transitions at its distal end to tip section 110. A length of applicator portion 104 as measured from handle 102 to tip 114 may be selected for comfort and optimum use. In one embodiment, the length of applicator portion 104 combined with handle 102 is about 9 inches, but other lengths may be selected without departing from the scope of the invention.

Neck section 106 may have a width substantially the same as handle 102 at its proximal end. The width typically increases approximately linearly to width 112 at the distal end of neck section 106 as it transitions to middle section 108.

Width 112 may be determined by a width of a joint to be sealed. For joints ranging from about 1/8 inch to about 3 inches, width 112 may vary from about 0.73 inches to about 1.52 inches. However, the invention is not constrained to these dimensions, and other dimensions may be readily employed.

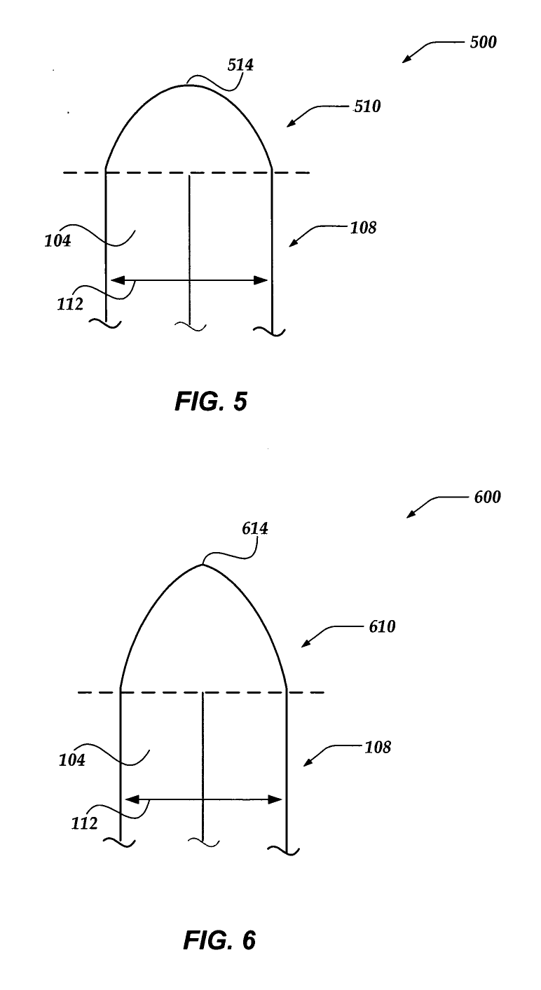

Tip section 110 includes a curvature substantially similar to a human finger tip. The curvature of tip section 110, called “spline radius” may be determined by width 112 and by a desired functionality of tool 100. The width and shape of the spline radius may determine what percentage of tool 100 comes into contact with the sealant during application. The percentage of contact surface may further determine an amount of sealant moved to the sides of a substrate and a depth of a concave sealant shape when cured. This provides for minimum smearing and maximum adherence, as well as improved esthetics such as a shadow line depth. The unique shape of tip section 110 allows a user to vary the percentage of contact surface by holding tool 100 at different angles in relation to the structure surface. By holding tool 100 at a predetermined angle during application, the user may vary percentage of contact surface between about 26% and about 38%. The percentage of contact surface may also be varied by selecting an “aggressive” shaped curvature or a “passive” shaped curvature for tip section 110 as discussed in more detail in conjunction with FIGS. 5 and 6 below.

To minimize marking, damaging, and scratching of softer architectural materials such as glass, painted substrates, tiles, and the like, tool 100 may be manufactured using various materials, including, but not limited to, polyurethane, nylon, polypropylene, accetal, and the like. These materials are selected to provide an optimum hardness, a flatness of the edges, and a smoothness of a surface of tool 100. These characteristics enable tool 100 to be “non-marking.”

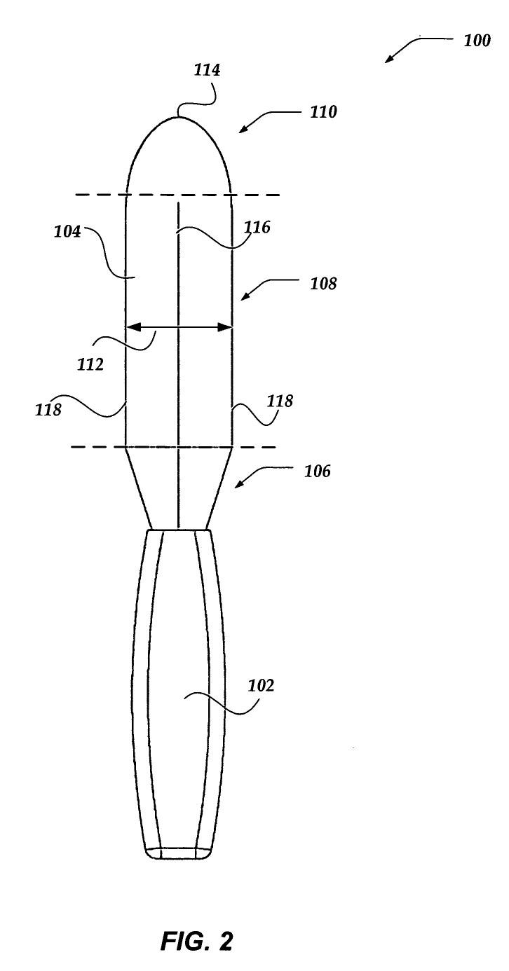

FIG. 2 illustrates a top view of tool 100 of FIG. 1. As shown in FIG. 2, width 112 of middle section 108 may be substantially constant throughout middle section 108. As described in FIG. 1, the curvature of tip section 110 may vary. Thickness of the center of applicator portion 104 along longitudinal axis 116 may be selected to provide optimum hardness and flexibility. In one embodiment the thickness is selected at about 0.25 inches. Depending on a sealant type to be applied, the thickness at the center may also vary reasonably around 0.25 inches. The thickness of applicator portion 104 may decrease from longitudinal axis 116 of applicator portion 104 towards edges 118 reaching about 0.05 inches at edges 118. Depending on a sealant type to be applied, the thickness at edges 118 may also vary reasonably around 0.05 inches.

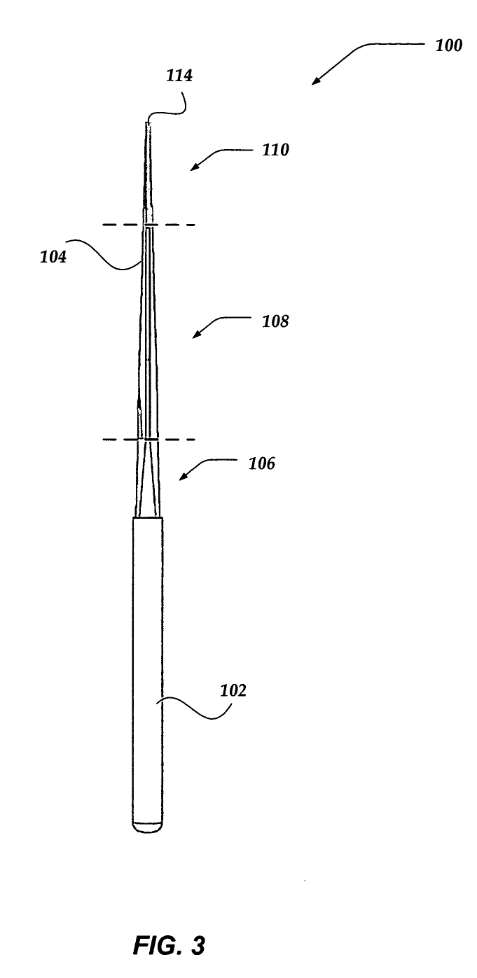

FIG. 3 illustrates a side view of tool 100 of FIG. 1. As shown in FIG. 3, the thickness of applicator portion 104 in neck section 106 may be determined as described in FIG. 2. In one embodiment the thickness is about 0.25 inches at the proximal end of neck section 106. Depending on a sealant type to be applied, the thickness neck section 106 may also vary reasonably around 0.25 inches. The thickness may decrease approximately linearly toward tip 114 reaching about 0.05 inches at tip 114. The thickness at tip 114 may vary reasonably around 0.05 inches to accommodate various sealant characteristics.

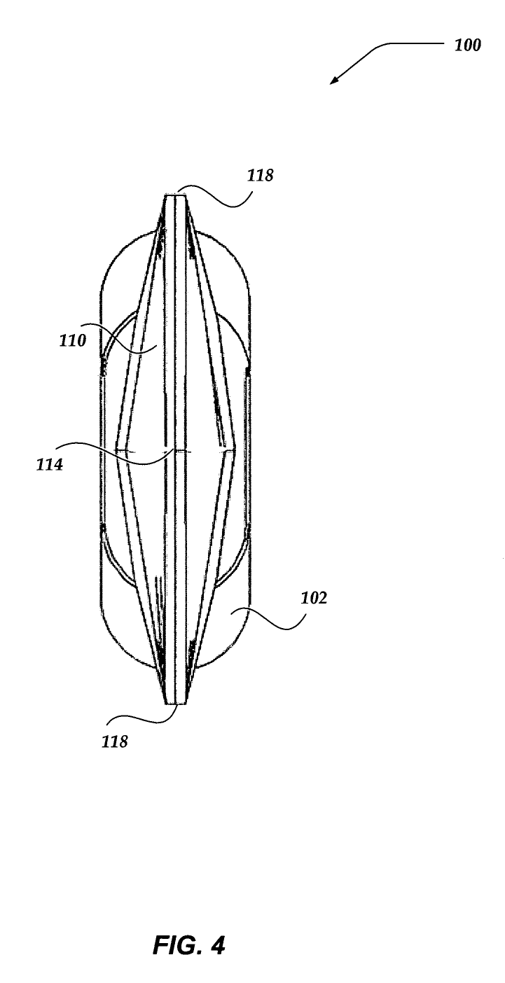

FIG. 4 illustrates a front view of tool 100 of FIG. 1. As shown in FIG. 4, tip 114 and edges 118 of applicator portion 104 may have the same thickness. The thickness of the center of applicator 104 may be determined for optimum hardness and flexibility as described in FIG. 3 above. Because tool 100 is substantially flat at tip 114, its unique curvature may also be used to remove any excess sealant that might be delivered to the joint. This may allow tool 100 to move an appropriate amount of sealant to the sides of the substrate, “wetting” its surfaces for adhesion to develop as desired.

FIG. 5 illustrates a partial top view of applicator portion 104 of tool 500 in accordance with one embodiment of the invention with a passive shaped curvature of tip section 510. Tool 500 is substantially similar to tool 100 of FIG. 1, except for the passive shaped curvature of tip section 514. As described above, width 112 may be substantially constant throughout middle section 108. Tip section 510 may have a spline radius selected to provide optimum adherence border while moving an appropriate amount of sealant to the sides of the substrate. The passive shaped curvature of tip 514, similar to a human finger tip, may create a less concave sealant shape with a flatter appearance. The appearance of the sealant in structural joints complements an overall esthetic of a structure in addition to providing a protection against elements. Tool 500 with passive shaped curvature may be used at angles varying between about 5 degrees and about 15 degrees during sealant application.

FIG. 6 illustrates a partial top view of applicator portion 104 of tool 600 in accordance with another embodiment of the invention with an aggressive shaped curvature of tip section 610. Tool 600 is substantially similar to tool 100 of FIG. 1, except for the aggressive shaped curvature of tip section 610. Tip section 610 with the aggressive shaped curvature has a steeper spline radius and a more pronounced tip 614. The aggressive shaped curvature is selected to provide an optimum adherence border while creating a more concave sealant shape with a deeper shadow line. Esthetics based on substrate materials and overall structure shape may encourage the deeper shadow line provided by this embodiment of tool 600. Tool 600 with aggressive shaped curvature may be used at angles varying between about 5 degrees and about 22 degrees during sealant application.

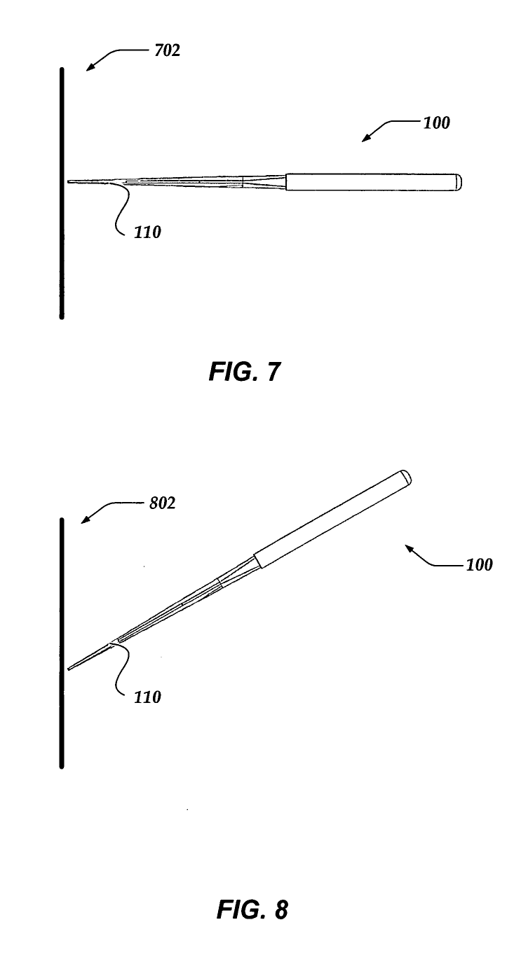

FIG. 7 illustrates a side view of tool 100 used at a right angle to substrate surface 702. When used at this angle during application of the sealant, tool 100 may enable maximum percentage of contact surface.

FIG. 8 illustrates a side view of tool 100 used at an acute angle to substrate surface 802. When used at this angle during application of the sealant, tool 100 may enable a smaller percentage of contact surface. An ability to change the percentage of contact surface through modification of the angle between tool 100 and substrate surface 802 may allow the user to maintain constant sealant shape even when a joint width varies.

Identified below are various embodiments in which the present invention may be practiced. These various embodiments provide a set of tools that may enable a user to apply sealant to joints with varying widths as well as varying sealant shapes.

In one embodiment, tool 100 may have a total length of about 9 inches. Handle 102 may be about 4 inches long. Applicator portion 104 may be about 5 inches long. Width 112 of applicator portion 104 may be about 0.75 inch, with tip section 110 having a length of about 1.09 inches. Tip section 110 may have the passive shaped curvature.

In another embodiment, tool 100 may have a total length of about 9 inches. Handle 102 may be about 4 inches long. Applicator portion 104 may be about 5 inches long. Width 112 of applicator portion 104 may be about 0.73 inch, with tip section 110 having a length of about 1.08 inches. Tip section 110 may have the aggressive shaped curvature.

In yet another embodiment, tool 100 may have a total length of about 9 inches. Handle 102 may be about 4 inches long. Applicator portion 104 may be about 5 inches long. Width 112 of applicator portion 104 may be about 0.87 inch, with tip section 110 having a length of about 1.07 inches. Tip section 110 may have the passive shaped curvature.

In a further embodiment, tool 100 may have a total length of about 9 inches. Handle 102 may be about 4 inches long. Applicator portion 104 may be about 5 inches long. Width 112 of applicator portion 104 may be about 0.87 inch, with tip section 110 having a length of about 1.11 inches. Tip section 110 may have the aggressive shaped curvature.

In a yet further embodiment, tool 100 may have a total length of about 9 inches. Handle 102 may be about 4 inches long. Applicator portion 104 may be about 5 inches long. Width 112 of applicator portion 104 may be about 1.06 inches, with tip section 110 having a length of about 1.00 inch. Tip section 110 may have the passive shaped curvature.

In another embodiment, tool 100 may have a total length of about 9 inches. Handle 102 may be about 4 inches long. Applicator portion 104 may be about 5 inches long. Width 112 of applicator portion 104 may be about 1.00 inch, with tip section 110 having a length of about 1.34 inches. Tip section 110 may have the aggressive shaped curvature.

In yet another embodiment, tool 100 may have a total length of about 9 inches. Handle 102 may be about 4 inches long. Applicator portion 104 may be about 5 inches long. Width 112 of applicator portion 104 may be about 1.52 inches, with tip section 110 having a length of about 1.75 inches. Tip section 110 may have the passive shaped curvature.

In a further embodiment, tool 100 may have a total length of about 9 inches. Handle 102 may be about 4 inches long. Applicator portion 104 may be about 5 inches long. Width 112 of applicator portion 104 may be about 1.28 inches, with tip section 110 having a length of about 1.34 inches. Tip section 110 may have the aggressive shaped curvature.

Although several embodiments of the invention have been illustrated and described, it will be appreciated that various changes may be made therein without departing from the spirit and scope of the invention. For instance the shapes of the tools according to different embodiments of the invention can be selected from a range of geometric shapes. Furthermore, the invention is not constrained to the listed dimension ranges, and other ranges may be readily employed.

1. A sealant tool for use in applying a sealant, comprising:
a handle having a substantially planar configuration; and
a substantially planar applicator portion having a fixed end that is joined to one end of the handle and a free tip section having a substantially spline radius that comprises a substantially non-marking material.

2. The sealant tool of claim 1, wherein the handle and the applicator portion are manufactured using substantially the same non-marking material.

3. The sealant tool of claim 1, wherein the handle and the applicator portion are integrated.

4. The sealant tool of claim 1, wherein the handle is manufactured using at least one of plastic, fiberglass, wood, polyurethane, and metal.

5. The sealant tool of claim 1, wherein the non-marking material further comprises at least one of polyurethane, polypropylene, nylon, and acetal.

6. The sealant tool of claim 1, wherein the applicator portion is manufactured employing a molded injection technique.

7. The sealant tool of claim 1, wherein the spline radius further comprises a passive shaped curvature.

8. The sealant tool of claim 1, wherein the spline radius further comprises an aggressive shaped curvature.

9. The sealant tool of claim 1, wherein the applicator portion further comprises a longitudinal axis and an edge, and wherein a thickness of the applicator portion is maximum along the longitudinal axis and decreases approximately linearly towards the edge.

10. The sealant tool of claim 9, wherein the thickness of the applicator portion is about 0.05 inches at the edge.

11. The sealant tool of claim 9, wherein the thickness of the applicator portion is about 0.25 inches at the longitudinal axis.

12. The sealant tool of claim 9, wherein the thickness of the applicator portion decreases approximately linearly along the longitudinal axis in the tip section.

13. The sealant tool of claim 1, wherein a length of the handle and the applicator portion combined is about 9 inches.

14. The sealant tool of claim 1, wherein a width of the applicator portion is determined based, in part, on a width of a joint to be sealed with the sealant tool.

15. The sealant tool of claim 14, wherein the width of the applicator portion ranges between about 0.73 inches and about 1.52 inches.

16. The sealant tool of claim 1, wherein a length and a width of the handle is determined for a comfortable gripping of the sealant tool.

17. The sealant tool of claim 1, wherein a surface of the handle further comprises at least one of a smooth finish and an indented finish.

18. A method of applying a sealant to a structural joint employing a sealant tool, comprising:
selecting the sealant tool comprising a tip with an aggressive shaped curvature or a tip with passive shaped curvature, based, in part, on an esthetic aspect associated with the structural joint; and
holding the sealant tool at a predetermined angle while applying the sealant, wherein the predetermined angle determines a depth of sealant shape.

19. The method of claim 18, wherein the predetermined angle of the sealant tool determines a percentage of contact surface.

20. The method of claim 18, wherein the percentage of contact surface controlled by the predetermined angle of the sealant tool varies between about 26% and about 38%.

21. A sealant tool for use in applying sealant, comprising:
a handle means having a substantially planar configuration; and
an applicator means having a substantially planar configuration and a substantially spline radius at its free distal end, wherein a proximal end of the applicator means is joined to the handle means, and wherein the applicator means employs a substantially non-marking means.

22. The sealant tool of claim 21, wherein the free distal end of the applicator means further comprises at least one of a passive shaped curvature and an aggressive shaped curvature.

23. The sealant tool of claim 21, wherein the non-marking means comprises at least one of polyurethane, polypropylene, nylon, and acetal.
